(19) United States
(12) Patent Application Publication
(10) Pub. No.: US 2006/0253813 A1
(43) Pub. Date: Nov. 9, 2006

(54) Design rule violations check (DRC) of IC's (integrated circuits) mask layout database, via the internet method and computer software

(76) Inventor: Dan Rittman, Durham, NC (US)

Correspondence Address: DANNY RITTMAN, 5101 STARCROSS LANE, DURHAM, NC, 27713, US

(21) Appl. No.: 11/120,262

(22) Filed: May 3, 2005

(51) Int. Cl. G06F 17/50

(52) U.S. Cl. 716/5

(57) ABSTRACT

This paper describes method and EDA (Electronic Data Automation) computer software invention for design rule violations check of mask layout database (integrated circuits layout) via the internet. The technique takes advantage of a unique algorithm to analyze the mask layout database to find mask layout polygons that are less than the minimum design rules (distances) that are determined by the fabrication process. The computer program then creates an output file that marks all design rule violations location and type. The input of the tool is a mask layout database (i.e.: layout block/s) that is made manually by a mask design specialist or automatically by automatic IC layout tools. The output of the software tool is a guideline mechanism and file to mark all design rule violations for correction. This markers file can be loaded into any industry's standard IC mask layout database editor for viewing and correction. The software performs on individual mask layout blocks and/or on hierarchical structure of mask layout blocks. The system also checks mask layout database incrementally, means only blocks that have been changed are checked. The system is activated via the internet using secured protocol. In order to reduce the cost of DRC (design rule check) computer program, corporations may log in to a main server to submit complete DRC (Design Rule Check) run. User point reference files at a local location (User's local computer) and setup all parameters on a web based interface. The system collects all local information and run a complete design rule check locally or on remote server. The system offer a web based control panel to execute all necessary setups for submitting design rule check over the internet using any secured internet browser like MS Explorer and Netscape. The system offers the option to run on a local machine (user's computer) or on the main server over the internet. The system also offers a PDA (Personal Digital Assistant) interface to launch DRC runs via industry's standard PDA's. The procedure is fully secured by 128 bit security protocol. The system supports existing industry standard rule decks like: Mentor's Calibre, Cadence's Assura and Synopsys's Hercules. All design rules can be easily imported from these rule decks to be used by DRC program on the main server. All necessary files including mask layout GDSII (or GSIII) file and technology file are securely encrypted using 128 bit protocol and send to the remote server. These files are decrypted on the remote computer and submitted for design rule check. The main remote server is distributing the task among other computer system for advanced parallel processing to achieve fast results. All results log files are encrypted using 128 bit security protocol and available for download by the user. In case of local design rule check the results files are available on the user's local machine. This approach eliminates the purchase of a full local license and enables affordable price for small and medium size chip design firms. This fact significantly reduces integrated circuits design cost and time to market factor for chip design corporations, enabling faster deliveries to their end customers.

### BACKGROUND OF THE INVENTION

This invention relates generally to the design of integrated circuits. As is well known, a large number of integrated circuit chips are manufactured on a single semiconductor wafer by a number of sequential steps. One or more process steps are involved in altering or forming a circuit layer. Several layers are sequentially built one on top of the other. The shape of the operation performed on each layer is defined by an optical mask.

Typically, a first process step is to diffuse or implant ions into the semiconductor wafer substrate in a pattern defined by a diffusion mask. A second step is then typically to form polysilicon gates in a pattern of another mask. A next step may be to form contacts with the polysilicon and substrate diffusion regions, and that is done by yet another mask. A next step is to connect the contacted gates and diffusions regions with metal conductors, so another mask is provided for defining conductor interconnections.

Although what has been described is typical, minimum process, many IC's required many more steps and thus several more layout masks for use in implementing those steps. Further, in certain cases, the sequence of the masking steps as described above may be different, and/or certain of the steps of this simple case may require two or more masks to implement.

In initially designing such an IC, a schematic diagram of the electronic circuit is first prepared. Such a diagram shows the interconnections of all of the electronic elements that are desired to be implemented on an integrated circuit chip. Once the schematic diagram is completed, it is tested with the use of available computer software tools. After it has been determined from these tests that an electronic circuit in accordance with the schematic diagram will operate as desired, this schematic is then converted into a mask design database that defines polygons on each set of masks. These masks are then optically fabricated for use in the manufacturing process (i.e.: layout).

Typically, a layout block is generated manually by a mask designer or an automated synthesizing software tool. (For example: Place and Route software tool). The output results are layout blocks that include design rule violations. A design rule violation means a physical distance between polygons that do not meet the manufacturing process distance criteria. During the conversion from the circuit's diagram to the layout database, the mask designer or synthesize automated tool creates some design rule violations between related polygons. When the entire layout block construction is done, then it is tested for design rule violations using a software tool (DRC—Design Rule Check). After design rule violations have been determined, the block will have to go through a process of manual ‘cleaning’ (correcting) of those violations. A ‘cleaning’ of such violations means moving related polygons to create a certain physical distance between them that will meet manufacturing process requirements. Avoiding doing so will create a wrong physical distance between layers on the actual wafer which may lead to electronic circuit failure.

The main advantage of the method and computer software that described in this invention is that users can submit design rule check via a web based control panel using any secured web browser. This design rule check can be executed on the inventor's remote sever or the user's local computer. The advantage of submitting design rule check on the inventor's server is based on the fact that this server is fast super computer system and will run in a very short time. The system is based on web based control panel and can be used with any secured web browser like MS Explorer or Netscape. User can setup design rule check using control panel's setup controls like check-boxes, buttons and pull-down menus. The communication with the main remote server is secured by 128 bit security protocol. All information remains fully confidential on the remote server. The main remote server is distributing design check among other computer system for parallel processing, achieving faster results. In case that the user choose to submit design rule check on his own local machine, the program offers an option to distribute the task on the user's local computer system for parallel processing to achieve faster results. When the design rule check is complete, the user will be notified via the control panel and an optional email message about the check completion. The system offers design rule check for the entire IC layout block or incremental run for the updated IC layout cells only. The system provides a graphical and textual representation for the run progress and completion. The system supports existing industry standard rule decks like: Mentor's Calibre, Cadence's Assura and Synopsys's Hercules. All design rules can be easily imported from these rule decks. All results log files are available on he remote server or the user local server by the user's choice. The system alerts the user about the completion of the design rule check by sending email and graphical representation on the web based control panel. The user is able to download all results files including violations marker file(s) to be loaded on mask layout database editor for visual viewing purposes.

Therefore, it is a primary object of the present invention to provide a method and software to submit design rule check of IC layout database via the internet using any secured web browser. This method saves a significant amount of time during IC layout design verification. This method enables integrated circuit design corporations to annually license web based design rule check system and therefore does not need to purchase complete DRC checker software which is very expensive. This method and system significantly reduce the cost of integrated circuits design rule check and make it affordable for small and medium size integrated circuits design corporations. This fact enables corporations to become more profitable and successful on the long run.

### SUMMERY OF THE INVENTION

This and additional objects are accomplished by the present invention, wherein, briefly, design rule violation check of IC mask layout database can be submitted via the internet using secured web browser.

The system offers a web based control panel to submit complete design rule checks over the internet. The user has the option to submit the design rule check locally (on his own computer system) or on a powerful remote server. In case of local run, the system checks with the remote server about the existence of a license and when it gets the approval, the design rule check will be submitted locally on the user's computer system. If the user chooses to submit design rule check on the remote server, few setups are required. These setups include the submission of a mask layout DGSII or GDSIII file and the technology file. All these files are encrypted and securely transmitted using 128 bit security protocol to the remote server. On the remote server all received information is decrypted and the design rule check is executed. The remote server is distributing all design rule checks on other computer systems for parallel processing to achieve faster results. In case of a local design rule check on the user's local computer, the system offers the option to distribute the design rule execution task among user's local computer systems for parallel processing to achieve faster results. After design rule check completion all necessary results log files and marker files are available for download directly from the remote server or to be load locally, in case of a local execution. The system offers the option to run design rule check in flat or fully hierarchical mode. Also the system offers incremental mode to run only the recent changed IC layout cells. Also by offering advanced servers, corporations may save the cost of purchasing high end computer systems for DRC verification and sign-off purposes. Offering advanced servers to submit design rule checks enable fast run time for very large databases.

Additional objects, advantages and features of the present invention will become apparent from the following description of its preferred embodiments, which description should be taken in conjunction of the accompanying drawings.

### BRIEF DESCRIPTION OF THE DRAWINGS

FIG. 1 schematically illustrates the system basic operation. The system includes remote internet computer system to prioritize and route multi-user, multi-technology design rule checks and main design rule check server that run multi-user design rule checks that are submitted over the internet.

### DESCRIPTION OF A PREFERRED EMBODIMENT

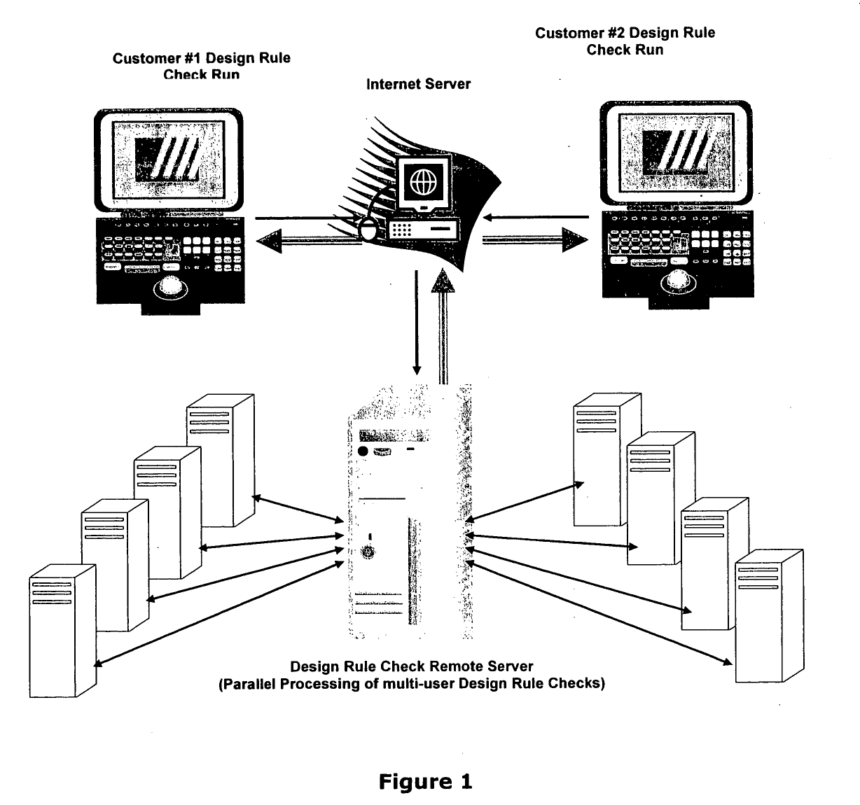

Referring to FIG. 1, conceptually illustrates is the schematic diagram of a VOI system. (Verification over Internet)

The system consists of two (2) major components. Component #1 is the internet server and component #2 is the design rule check server. The internet server is a powerful computer to route all design rule checks requests according to priority and queue to design rule check server. The design rule check remote server is a powerful super computer that distributes all design rule checks information for parallel processing execution on other computer systems at the main inventor's location. The main computer program is running on the design rule check remote server and can handle multi-user, multi-technology design rule checks execution. In addition the system is compatible with existing industry's standard rules decks like: Mentor's Calibre, Cadence's Assura/DIVA and Synopsys's Hercules. All design rules can be easily read using the import feature to read directly from existing rule deck. All technology files and design rule check setups are encrypted before sent to the main design rule check server. This information then is decrypted at the main design rule check server and executed. A separate computer program that is synchronized with the design rule check program and is running on the internet server to manage design rule checks requests traffic, priority and queue. When each design rule check is complete all results are automatically available on the main design rule check remote server. The design rule check remote server informs the internet server about the design rule check completion, which inform the user about the run completion and the availability of the result files.

It is important to mention that the computer software is working on GDSII and GDSIII Stream format database (industry standard IC layout representation database) which covers all the commercial layout editors in the VLSI field today.

1. Software and method for analyzing and find design rule violations in IC (integrated circuit) mask layout database, to produce markers file output with violations location and type, activated via the internet using any secured web browser like MS Explorer and Netscape.

2. The software and method according to claim 1 wherein the design rule check is done on the remote server or the user's local server according to the user's choice.

3. The software and method according to claim 1 wherein said that the remote server may distribute the design rule check among other servers for parallel processing to achieve faster results.

4. The software and method according to claim 1 offers a web based control panel for design rule check submission, setups and execution.

5. All users' information is encrypted using 128 bit security protocol and sent to the remote server.

6. The software and method according to claim 1 include an internet traffic server to route all design rule check to the main execution remote server according to priority and queue.

7. The software and method according to claim 1 can import industry's standard technology files for extracting design rule information. The system supports existing industry standard rule decks like: Mentor's Calibre, Cadence's Assura and Synopsys's Hercules. All design rules can be easily imported from these rule decks.

8. The software and method according to claim 1 wherein said produces an output marker file with all design rule violations location and type. This markers information can be load into any industry's standard IC layout editor for viewing

9. The method according to claim 8, wherein the markers result file is available for download by the user from a secure internet location or the user's local machine, in case a local run was chosen.

10. The software and method according to claim 1 included a design rule check computer program that is executing on the remote server for design rule check purposes.

11. The method and system according to any one of claims 1, wherein the design rule violation check is been performed on a flat IC mask database and/or hierarchical IC mask layout database.

12. The method and system according to claim 1, wherein said design rule check run can be launched via standard PDA (Personal Digital Assistant) with an access to the internet.

13. The method and system according to claim 1, wherein said design rule check run can be launched via any secured internet browser with an access to the internet using the programs' control panel.

14. The method and system according to claim 1 provides all design rule check output files setup through web based control panel.

15. The method and system according to claim 1 can be run via cellular devices or any WiFi and WiMax technology based computer with an access to the internet.

16. The method and system according to claim 1 supports multi-user, multi-technology design rule check executions and analysis.

17. The method and system according to claim 1 provides secured password based internet control panel that is directly connected to the internet server for design rule check run route and execution.

18. The method and system according to claim 1 alerts the user about the design rule check completion via email and graphical representation show on the web based control panel.

19. The method and system according to claim 1 provides run-time graphical and textual indicators to show the design rule check run progress and completion time estimation.

20. The method and system according to claim 1 provides incremental design rule check option to run only changed IC layout cells.
